(19) United States
(12) Patent Application Publication
(10) Pub. No.: US 2026/0145088 A1
(43) Pub. Date: May 28, 2026

(54) MULTI-SPORT MANAGEMENT SIMULATION

(71) Applicant: Squizplay LLC, San Diego, CA (US)

(72) Inventors: Brad KATES, San Diego, CA (US); Alejandro Raul SERRANO, Los Angeles, CA (US); Joe DETUNO, Calabasas, CA (US); Sean WHITLEY, Edwards, MO (US)

(21) Appl. No.: 19/399,568

(22) Filed: Nov. 24, 2025

Related U.S. Application Data
(60) Provisional application No. 63/725,449, filed on Nov. 26, 2024.

(51) Int. Cl. A63F 13/828; A63F 13/87

(52) U.S. Cl. CPC A63F 13/828; A63F 13/87; A63F 2300/1075; A63F 2300/69

(57) ABSTRACT

Certain aspects of the disclosure provide a computer-implemented method for managing a multi-sport fantasy application. One aspect includes enabling a user to draft a lineup comprising teams and/or individual players from multiple sports leagues; and displaying multiple user interface pages for navigating and interacting with the application, including a scoreboard page presenting multi-sport scoring information.

### CROSS REFERENCE TO RELATED APPLICATIONS

This Application claims the benefit of and priority to U.S. Provisional Patent Application Ser. No. 63/725,449, filed Nov. 26, 2024, the entirety of which is incorporated by reference herein.

### BACKGROUND

### Field

Aspects of the present disclosure relate to simulation of sports management, and in particular to management of multiple sports leagues as a sports “mogul.”

### Description of Related Art

Fantasy sports applications have become a popular form of entertainment and competition among sports enthusiasts. These applications allow users to create and manage virtual teams composed of real-life athletes, whose performance in actual games contributes to the users'fantasy team scores. Historically, the primary focus of fantasy sports applications has been on managing player rosters within a single sports league. For example, fantasy football applications typically allow users to draft and manage players from the National Football League (NFL), while fantasy basketball applications focus on players from the National Basketball Association (NBA).

This single-league focus has been a defining characteristic of traditional fantasy sports applications. Users engage in drafting, trading, and setting lineups based on the performance of athletes within the confines of one specific league. This approach simplifies the management of player statistics, scoring systems, and league-specific rules, making it easier for users to follow and participate in the fantasy sports experience.

However, this traditional model has limitations. Sports enthusiasts often follow multiple sports and leagues, and their interests are not confined to a single sport. The existing fantasy sports applications do not cater to users who wish to create and manage rosters that span multiple sports leagues. For instance, a user who is a fan of both football and basketball would need to participate in separate fantasy leagues for each sport, managing distinct rosters and adhering to different sets of rules and scoring systems.

There is demand for a more integrated fantasy sports experience that allows users to manage rosters of sports teams across multiple sports leagues. This multi-league approach would provide a more comprehensive and engaging experience for users, reflecting their diverse sports interests and offering a unified fantasy sports management system.

### SUMMARY

Certain aspects provide a computer-implemented method for managing a multi-sport fantasy application comprises enabling a user to draft a lineup comprising a plurality of teams and/or individual players, wherein the lineup includes teams for team sports and individual players for individual sports, and the lineup includes teams and/or individual players from a plurality of sports leagues; displaying multiple user interface pages for navigating and interacting with the application, including a draft room page comprising a draft order subpage, a draft date subpage, a draft teams subpage, an individual league subpage, and a scoreboard page; and presenting multi-sport scoring information on the scoreboard page, wherein the multi-sport scoring information includes scores for each team and/or individual player in the user's lineup, and scores for each team and/or individual player in a competitor's lineup.

Other aspects provide processing systems configured to perform the aforementioned method as well as other methods described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example draft order page in a draft room, which is part of a user interface for an example sports mogul application.

FIG. 2 depicts an example dates subpage within the draft room of a user interface for an example sports mogul application.

FIG. 3 depicts an example teams subpage within the draft room of a user interface for an example sports mogul application prior to any teams being drafted.

FIG. 4 depicts an example of a league subpage within the draft room of a user interface for an example sports mogul application showing teams that have been drafted by mogul “Me.”

FIG. 5 depicts an example of a league drafting subpage within the draft room of a user interface for an example sports mogul application.

FIG. 6 depicts an example teams page within the draft room of a user interface for an example sports mogul application.

FIG. 7 depicts an example notifications page of a user interface for an example sports mogul application depicting various notifications related to a draft.

FIG. 8 depicts an example scoreboard page of a user interface for an example sports mogul application.

FIG. 9 depicts an example of a league scoring page of a user interface for an example sports mogul application.

FIG. 10 depicts an example computer-implemented method for managing a multi-sport fantasy application.

FIG. 11 depicts an example processing device configured to implement the sports mogul application described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for managing rosters of sports teams across multiple sports leagues in a fantasy sports application. Aspects described herein address the aforementioned need in the fantasy sports domain by providing a fantasy sports application that allows users to manage rosters of sports teams across multiple sports leagues. This innovative approach enhances the traditional fantasy sports experience by offering greater flexibility and a more holistic view of users'sports interests. By integrating multiple sports leagues into a single application, users can enjoy a seamless and enriched fantasy sports experience, managing their favorite athletes from different sports within one cohesive platform.

Various aspects described herein relate to a multi-sport fantasy application, referred to herein as the “sports mogul application.” This application allows users, referred to as sports “moguls,” to draft entire teams or individual players into their lineup, rather than being limited to individual players within a single sports league. This innovative approach provides a more comprehensive and engaging fantasy sports experience by allowing users to manage rosters that span multiple sports leagues, including professional, collegiate, and international competitions.

The sports mogul application enables users to draft lineups that include teams for team sports and individual players for individual sports. For example, a mogul's lineup may include a football team from the National Football League (NFL) and an individual golfer from the Professional Golfers'Association (PGA) Tour. This flexibility allows users to create diverse lineups that reflect their varied sports interests, enhancing the overall appeal and engagement of the application.

The sports mogul application supports drafting from a wide range of sports leagues. Examples of popular American professional sports, include: National Football League (NFL): the premier professional football league in the United States; Major League Baseball (MLB): the highest level of professional baseball in the United States; National Basketball Association (NBA): the top men's professional basketball league in the United States; National Hockey League (NHL): the major professional ice hockey league in North America, encompassing teams from the United States and Canada; Major League Soccer (MLS): the professional soccer league representing the United States and Canada; Women's National Basketball Association (WNBA): the premier professional women's basketball league in the United States; National Women's Soccer League (NWSL): the top women's professional soccer league in the United States; Professional Golfers'Association Tour (PGA or PGA Tour): the main professional golf tour in the United States for men; Ladies Professional Golf Association Tour (LPGA or LPGA Tour): the premier professional golf tour for women; National Association for Stock Car Auto Racing (NASCAR): the governing body for the sport of stock car racing in the United States; and Ultimate Fighting Championship (UFC): the leading mixed martial arts (MMA) promotion company in the United States.

Examples of popular American collegiate sports include: National Collegiate Athletic Association (NCAA) Football: the primary governing body for college football, consisting of multiple divisions (Division I, Division II, and Division III); NCAA Men's Basketball: the collegiate basketball competition for men under the NCAA's governance; NCAA Women's Basketball: the collegiate basketball competition for women governed by the NCAA; NCAA Baseball: the college baseball competition organized by the NCAA; NCAA Softball: collegiate women's fast-pitch softball governed by the NCAA; NCAA Ice Hockey: collegiate ice hockey competitions for men and women under NCAA's governance; NCAA Soccer: college soccer competitions for men and women organized under the NCAA; NCAA Track and Field: collegiate competitions in track and field events, both indoor and outdoor, governed by the NCAA.

These leagues represent some of the most prominent competitive sports in the United States, spanning a wide range of interests and athletic disciplines. However, sports leagues from around the world may also be included in a sports mogul's lineup.

Examples of popular foreign professional sports include: Formula One: the top tier open wheel racing league, which races in more than twenty countries each year; English Premier League (EPL): the top division of professional football (soccer) in England; La Liga: the premier professional football (soccer) league in Spain, officially known as the Primera División; Bundesliga: the top professional football (soccer) league in Germany; Serie A: the highest professional football (soccer) league in Italy; Ligue 1: the premier professional football (soccer) league in France; Confederation of North, Central America and Caribbean Association Football (CONCACAF) Champions League: a continental club football (soccer) competition for teams from North America, Central America, and the Caribbean; Union of European Football Associations (UEFA) Champions League: an annual club football (soccer) competition organized by UEFA, featuring top-division European clubs; Indian Premier League (IPL): a professional Twenty20 cricket league in India; Australian Football League (AFL): the professional Australian rules football league in Australia; Super Rugby: an international men's rugby union competition involving teams from Australia, New Zealand, South Africa, Argentina, and Japan; European Rugby Champions Cup: the top-tier European club rugby union competition; EuroLeague: the top-tier European professional basketball club competition; Kontinental Hockey League (KHL): an international professional ice hockey league in Eurasia, primarily featuring teams from Russia; and Big Bash League (BBL): a professional Twenty20 cricket league in Australia.

Examples of popular foreign collegiate sports include: British Universities and Colleges Sport (BUCS): the governing body for university sports in the United Kingdom, organizing competitions and leagues across multiple sports; Canadian Interuniversity Sport (CIS): now known as U Sports, the national governing body for university sports in Canada, overseeing various collegiate competitions; University Sports South Africa (USSA): the governing body for university sports in South Africa, organizing domestic inter-university competitions; and All India Inter-University Championships: organized by the Association of Indian Universities (AIU), these championships cover various sports disciplines at the university level in India.

Examples of world or international sporting competitions include: Olympic Games: a leading international sporting event featuring summer and winter sports competitions, where thousands of athletes from around the world participate in a variety of competitions. The Games are held every four years, alternating biennially between the Summer and Winter Olympics; FIFA World Cup: the most prestigious international football (soccer) tournament, organized by the Fédération Internationale de Football Association (FIFA), and held every four years. There is a separate tournament for men's and women's teams; the Paralympic Games: an international multi-sport event for athletes with disabilities, held shortly after the Olympic Games, featuring both summer and winter events; World Athletics Championships: an elite track and field competition organized by World Athletics, the global governing body for athletics (track and field), held every two years; Rugby World Cup: the premier international championship for rugby union, contested every four years among national teams; Cricket World Cup: the international championship of One Day International (ODI) cricket, organized by the International Cricket Council (ICC) and held every four years; FIBA Basketball World Cup: the leading international basketball championship for men's national teams, organized by the International Basketball Federation (FIBA), held every four years; Tennis Grand Slams: while not team-based, these four annual events are considered the most prestigious in tennis: Australian Open, French Open (Roland Garros), Wimbledon Championships, US Open; UEFA European Championship (Euro): the primary football (soccer) competition for national teams in Europe, organized by the Union of European Football Associations (UEFA), held every four years; the Commonwealth Games: an international multi-sport event involving athletes from the Commonwealth of Nations, held every four years; Asian Games: a continental multi-sport event held every four years among athletes from all over Asia; African Cup of Nations (AFCON): the main international football competition in Africa, organized by the Confederation of African Football (CAF) and held every two years; Copa América: the main international football (soccer) tournament for national teams in South America, organized by the South American Football Confederation (CONMEBOL); and Pan American Games: a multi-sport event featuring summer sports in which athletes from the Americas compete, held every four years.

Any of the aforementioned sports can be included in a sport mogul's lineup in a sports mogul application. Such an application may generally be configured with specific sports based on user preferences for which moguls will select teams (or individual athletes as appropriate) to form their lineup. This extensive selection of sports leagues ensures that users can draft teams and individual players from their favorite sports, providing a more inclusive and engaging fantasy sports experience.

Several draft orders can be employed when choosing a sports mogul's lineup, each impacting the strategic dynamics of the draft. Common draft orders include the “snake draft,” where the draft order reverses in each subsequent round, and the “linear draft,” where the draft order remains the same throughout the entire draft. The application also supports less common draft orders, such as the “auction draft,” where participants bid on teams and players using a virtual budget, and the “third round reversal,” where the draft order reverses after the third round. This variety of draft orders provides users with multiple strategic options, making the draft process more dynamic and engaging.

The sports mogul application utilizes various types of scoring schemes to generate points for a user's lineup. In conventional fantasy sports, statistics associated with individual players contribute to an overall score. In the sports mogul application, scoring can be based on team-level statistics, such as the total yards gained in offense for a football team or the number of points scored during a game for a basketball team. The application allows for customizable scoring settings, enabling league commissioners to set and modify scoring characteristics to suit the preferences of the moguls in the league. This flexibility ensures that the scoring system can be tailored to the specific needs and interests of the users.

An example sports mogul application includes multiple user interface (UI) pages, with various UI elements for navigating and interacting with the application. The “draft room” page comprises several subpages, including a “draft order” subpage, a “draft date” subpage, a “draft teams” subpage, and an “individual league” subpage. The draft order subpage depicts a grid with leagues on one axis and moguls on another axis, showing the draft order in which the individual moguls draft different teams within the leagues. The draft date subpage lists or grids draft times for each league from which teams and/or players are being drafted. The draft teams subpage shows each mogul's drafted lineup of teams and/or players, while the individual league subpage lists available teams or individual players to draft and includes a user interface element for selecting a specific mogul and viewing their drafted teams and/or players.

The application also includes a “scoreboard” page that presents multi-sport scoring information for each mogul and each league in which the moguls have teams and/or individual players. The scoreboard page may include a table with leagues on one axis and moguls on another axis, the table indicating how many points each mogul has obtained in each league. It may also include a total or summation element giving overall scores across all leagues for each given mogul. The scoreboard page can display anticipated or predicted scores as well as actual scores, using different treatments (e.g., font colors, sizes, emphases) to depict different competitive aspects, such as when a score is above or below a prediction or when a mogul is winning or losing in a league.

In addition to the aforementioned features, the sports mogul application may include several enhancements to improve the user experience. For example, the application may provide real-time updates of player and team statistics, ensuring that users have the most current information available. It may also include a notification system to alert users of important events, such as draft start times or scoring updates. The application may also allow users to trade teams and/or individual players with other users, adding another layer of strategy and interaction. Users can create and join private leagues, providing a more tailored and enjoyable experience. The application may also include a chat feature for users to communicate during the draft, enhancing the social aspect of the application.

The beneficial technical effects of the present invention are significant. By allowing users to draft lineups comprising teams and individual players from a variety of sports leagues, the sports mogul application provides a more comprehensive and flexible fantasy sports experience. This approach accommodates both team and individual sports, enhancing the appeal and inclusivity of the application. The structured user interface design, including the draft room page and scoreboard page, ensures that users can easily navigate the application, manage their lineups, and track their performance. The customizable scoring schemes, variety of draft orders, notification system, trading feature, league creation and joining options, and communication capabilities all contribute to a more engaging, dynamic, and enjoyable fantasy sports experience.

In contrast to conventional fantasy applications that focus on a single sports league, the aspects described herein enable a multi-league approach that reflects the diverse interests of sports enthusiasts. Thus, aspects described herein provide a more holistic view of users'sports interests and offers a unified fantasy sports management system, making it a significant improvement over existing applications.

### Example Sports Mogul Application

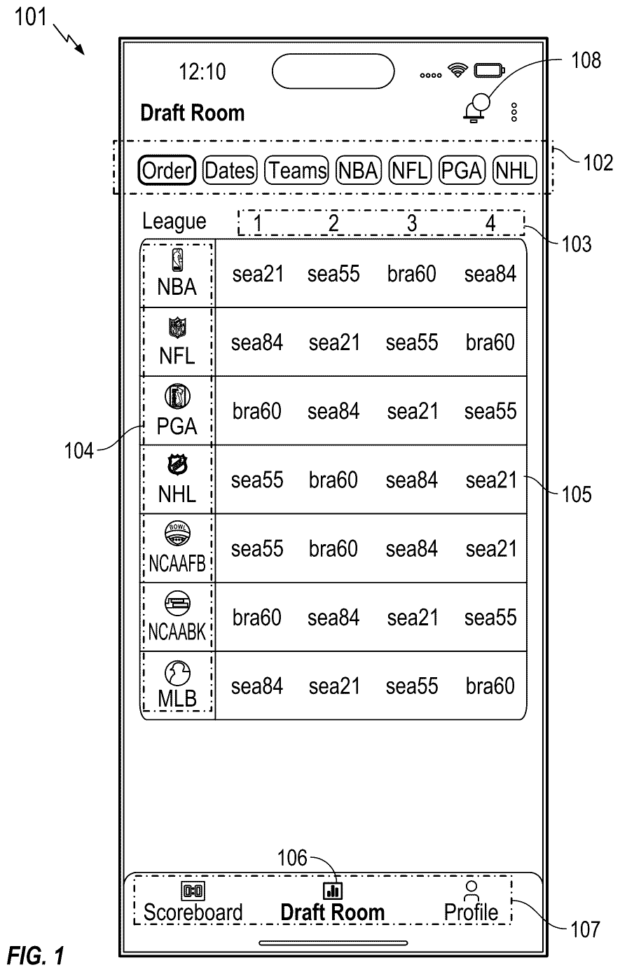

FIG. 1 depicts an example draft order page 101 in a draft room, which is part of a user interface for an example sports mogul application.

The draft room page includes user interface elements 102 across the top, which when selected bring up different information regarding the draft. The currently displayed page 101 depicts a draft order in which four different sports moguls 103 (in this example, but in other examples it could be other numbers of sports moguls) choose teams from six different leagues 104, including NBA, NFL, PGA, NHL, NCAAFB, NCAABK, and MLB. Note that in other examples, fewer or more leagues could be configured for drafting of a sports mogul's lineup.

The grid 105 formed by the four sports moguls 103 and six leagues 104 includes sports mogul names indicating the order in which each sports mogul will draft among the leagues. In this example, the draft order is a “snaking order,” but in other examples, it could be a different order.

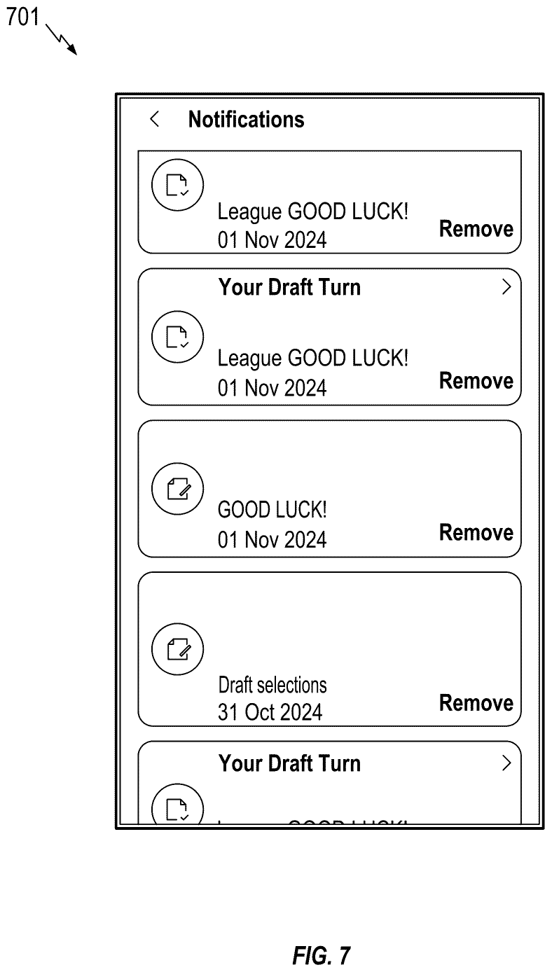

The draft room page further includes a notification user interface element 108 that causes a notifications page to be displayed, an example of which is depicted in FIG. 7.

The draft room page 101 may be selected directly be a user interface element (button in this example) 106 along the bottom of the example user interface. The user interface element 106 in this example is configured within a permanent user interface banner element 107, which is persistent across various pages, as depicted in the figures described below.

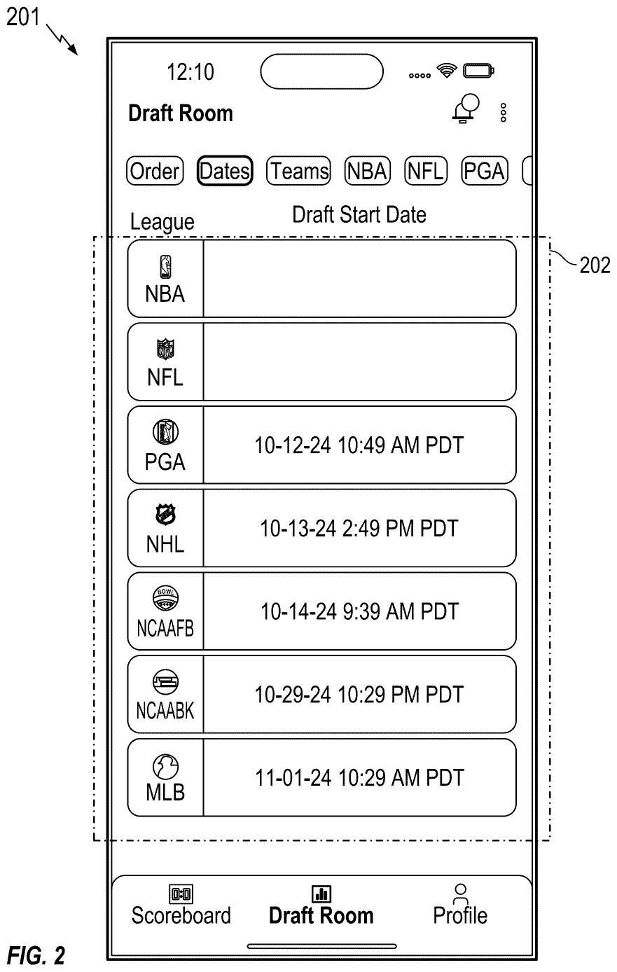

FIG. 2 depicts an example dates subpage 201 within the draft room of a user interface for an example sports mogul application. Specifically, the draft time and date for each league (e.g., NBA, NFL, etc.) is depicted in the ordered elements 202. In this case, the different leagues are drafted at different times, but in other examples the drafting may be done concurrently.

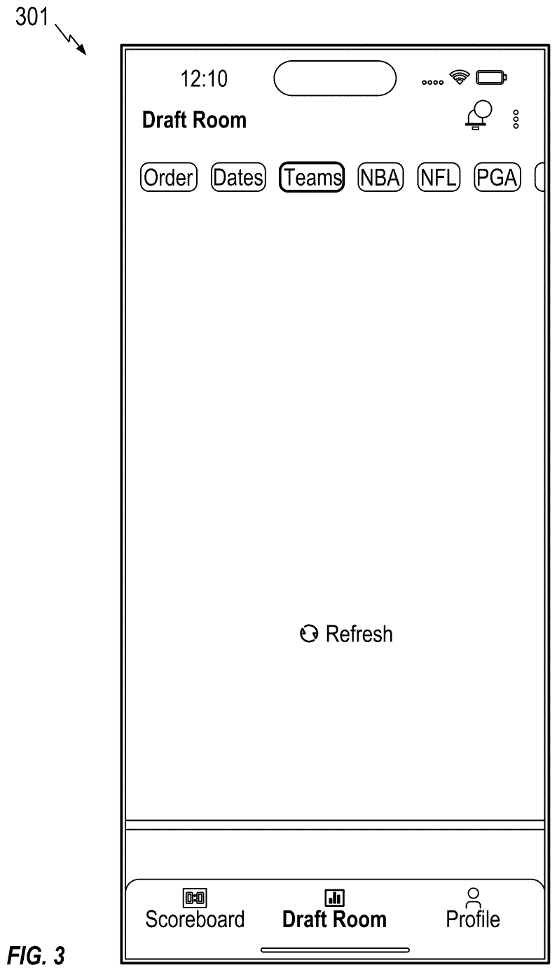

FIG. 3 depicts an example teams subpage 301 within the draft room of a user interface for an example sports mogul application prior to any teams being drafted. In some examples, where a league comprises individual players, (e.g., PGA), the teams subpage 301 may depict drafted players instead of teams.

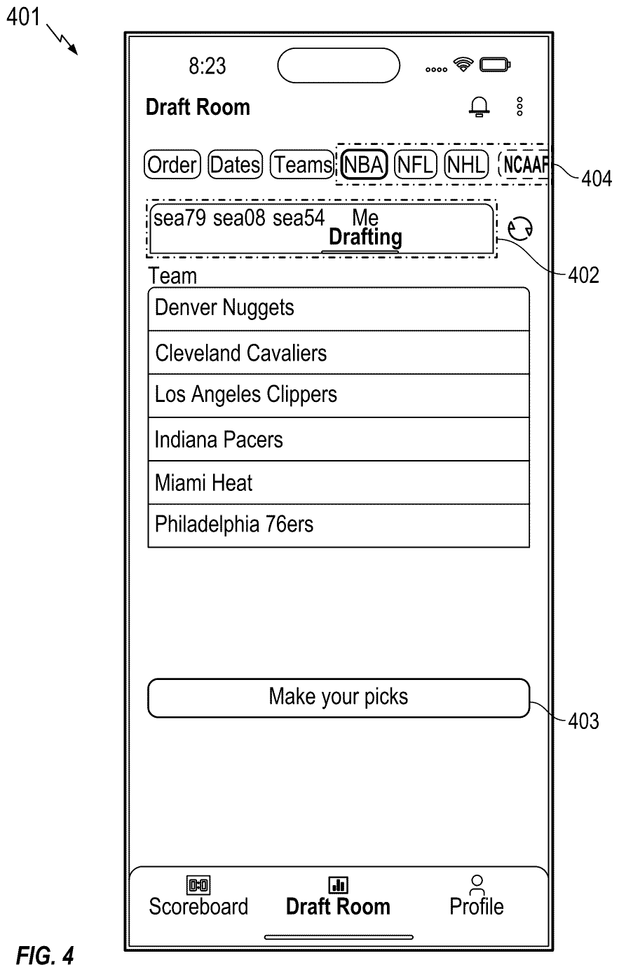

FIG. 4 depicts an example of a league subpage 401 (here, NBA) within the draft room of a user interface for an example sports mogul application during the draft, e.g., at the draft time and date for the league shown on dates subpage 201 in FIG. 2. The league subpage 401 shows teams that have already been drafted by sports mogul “Me.” The user interface element 402 allows for selecting other sports moguls to see which teams they have drafted within the league subpage 401. The user interface element 402 further includes an indication of who is drafting, which in this case is mogul “Me” as indicated by the underline and the “Drafting” text.

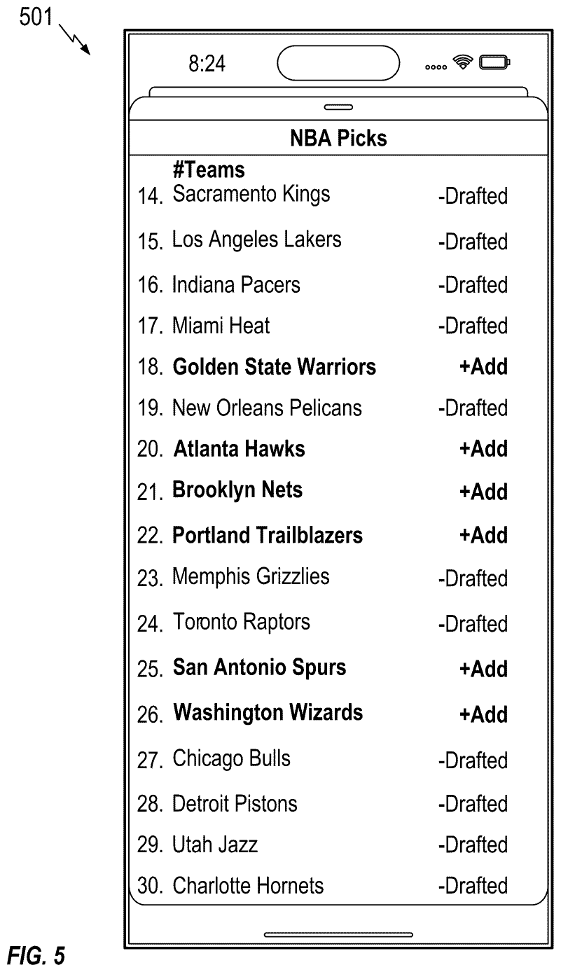

The user interface element 403 (a “Make your picks” button in this example) allows for drafting additional teams, and causes a new subpage to be depicted as described with respect to FIG. 5. In some aspects, the user interface element 403 may be displayed or may be emphasized (e.g., change in color, size, etc.) when it is the sports mogul's turn to draft, and may otherwise be suppressed or deemphasized.

For example, during a sports mogul's turn to draft, the user interface element 403 may be emphasized and facilitate drafting of a team (e.g., for a team-based league), or an individual player (e.g., for an individual-based league).

Note that while one league subpage 401 is depicted in FIG. 4, a user may move between other leagues (e.g., via user interface elements 404) by selecting associated user interface elements (buttons in this example), such as “NFL” and “NHL” in this example.

FIG. 5 depicts an example of a league drafting subpage 501 within the draft room of a user interface for an example sports mogul application, such as may be depicted after selecting the user interface element 403 in FIG. 4. The league drafting subpage 501 indicates which teams (or in some examples, individual players) within a given league have been drafted already (e.g., with UI element “−Drafted”) and which are available for drafting (e.g., with UI element “+Add”). Note that while the example 501 does not show which mogul drafted each team, in another example, the UI element indicating drafted could include the mogul that drafted a particular team.

In some examples, a sports mogul may draft a team by selecting a UI element associated with the team. In some examples, a UI element associated with a team which has already been drafted (e.g., with UI element “−Drafted”) may prevent or restrict selection of the UI element, thereby restricting drafting of the team by the sports mogul during their drafting turn.

In some examples, during a sports mogul's turn to draft, the sports mogul may be able to draft more than one team, for example, by selecting UI elements associated within one or more team. In one example, where a sports mogul may draft more than one team, UI elements may appear to indicate the number of teams already drafted, or the number of teams remaining to be drafted by the sports mogul.

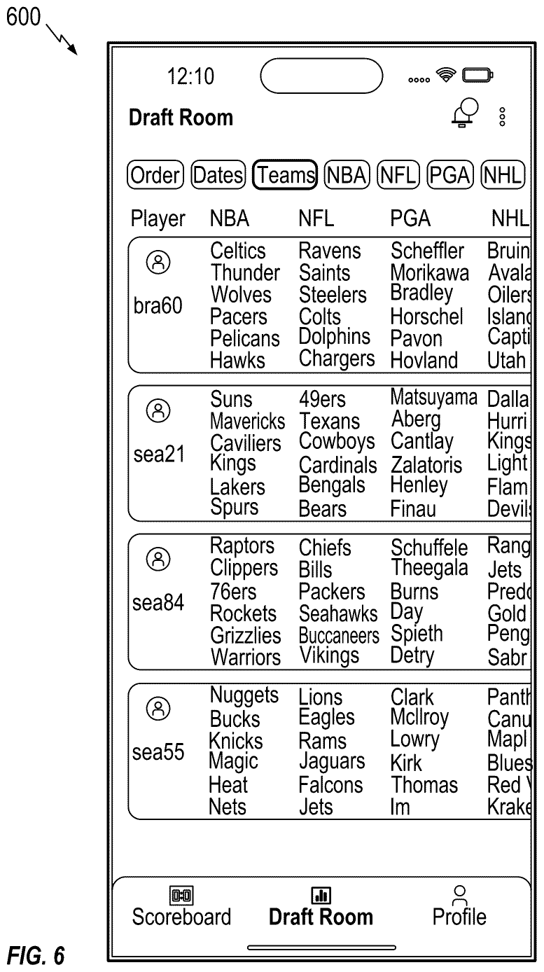

FIG. 6 depicts an example teams page 601 within the draft room of a user interface for an example sports mogul application. Specifically, the teams page 601 shows which teams in the various leagues that have been drafted by which moguls. In this example, each mogul has drafted a number of teams configured for each league, such as six NBA teams, 6 NFL teams, 6 individual golfers from the PGA, etc. In other examples, these numbers may be different and may be configured on a per-league basis.

FIG. 7 depicts an example notifications page 701 of a user interface for an example sports mogul application depicting various notifications related to a draft. Each of the notifications may be selected to view more details or deleted via the “Remove” user interface element. The notifications page may be accessed from various pages including the notification user interface element, such as 107 in FIG. 1.

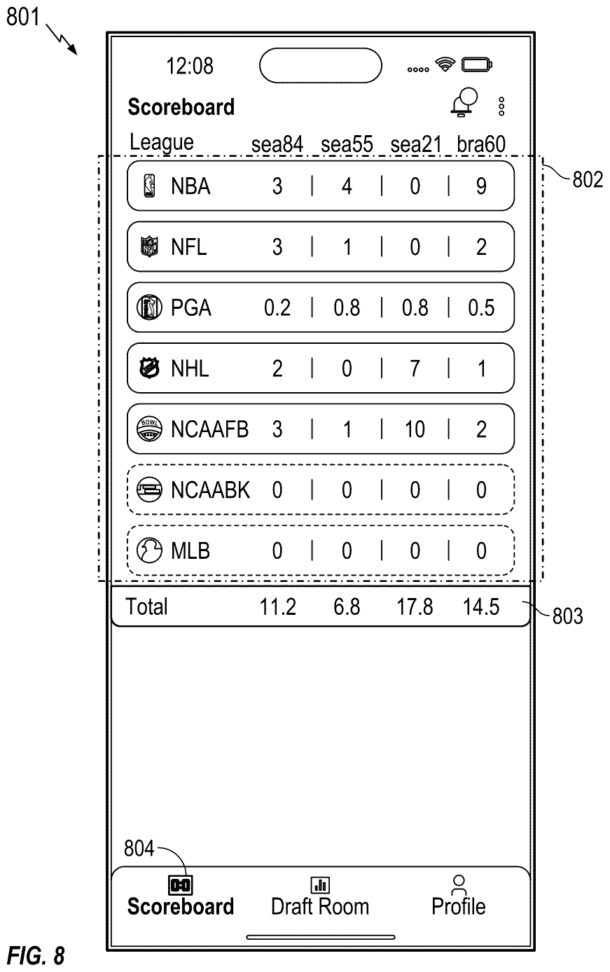

FIG. 8 depicts an example scoreboard page 801 of a user interface for an example sports mogul application. In this example the scoreboard 802 arranges leagues along one axis (vertical in this example) and moguls along another axis (horizontal in this example). Each league has a user interface element within the scoreboard depicting the score obtained by each mogul in that league according to the scoring scheme configured by, for example, a mogul league administrator.

The scoreboard page 801 further includes a total score user interface element 803, which presents each moguls total score across the various sports leagues (e.g., NBA, NFL, PGA, etc.) in this example. Note that any number of sports leagues can be included in a mogul league, and in this example seven different leagues are included.

In some examples, the total score user interface element 803 may be fixed in place, or configured to always be visible without regard the number of sports leagues configured for the mogul league. In such cases that there are more sports leagues that can be displayed at once, a user may scroll (e.g., up and down) to view the various sports leagues in the scoreboard 802.

The scoreboard page 801 is generally accessible from a user interface element (button in this example) 804.

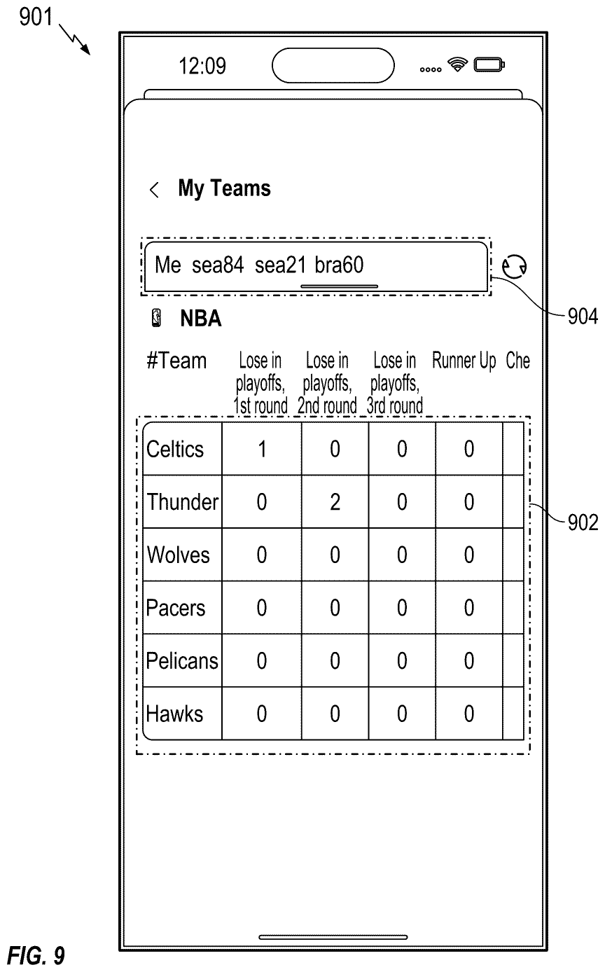

FIG. 9 depicts an example of a league scoring page 901 of a user interface for an example sports mogul application. The league scoring page 901 includes a scoring matrix 902 showing points earned for each of a variety of scoring opportunities 903, such as may be defined by a scoring scheme. As depicted, the scoring matrix for any mogul may be selected via the user interface element 904.

The sports mogul application can be implemented as a web-based application that can be accessed on mobile devices (e.g., tablet computers and smartphones), desktop computing devices, server computing devices, or in a native application on any of the aforementioned device types. Generally, the sports mogul application provides users with a convenient and accessible platform for managing their multi-sport fantasy lineups.

A typical processing device suitable for running the sports mogul application may include several components and features that enable its functionality. For example, the processing device may comprise one or more central processing unit(s) (CPU(s)) that execute the application software, handling tasks such as user input processing, data management, and communication with external servers. The CPU may be supported by one or more memories, including random access memory (RAM) and storage memory, which provide the necessary resources for running the application and storing user data, including drafted lineups, scoring information, and league settings.

In some implementations, the mobile device includes a graphics processing unit (GPU) configured to accelerate rendering and visualization of the sports mogul application's user interface. The GPU may comprise a multi-core shader architecture with a plurality of programmable compute units, each including scalar and vector ALUs, texture sampling units, and a local register file, to execute graphics and general-purpose parallel workloads. The GPU can support modern graphics and compute APIs, such as OpenGL ES, Vulkan, and Metal, enabling efficient execution of scene composition, 2D/3D animations, text and icon rasterization, and real-time transitions across, for example, draft room, scoreboard, and league subpages. In certain aspects, the GPU includes a tile-based deferred rendering pipeline with on-chip tile buffers to reduce external memory bandwidth during rasterization of layered UI elements, thereby improving power efficiency. The GPU may further incorporate a hardware compositing engine for offloading window and layer blending, a display controller for driving high-refresh-rate touch displays, and dedicated video encode/decode blocks for rendering embedded media. The GPU can share a unified memory subsystem with the application processor, employing bandwidth-saving features such as lossless framebuffer compression and variable rate shading to maintain responsive frame rates while conserving battery life.

In some implementations, the mobile device includes a touchscreen display that serves as the primary user interface for the sports mogul application. The touchscreen allows users to interact with the application through touch gestures, such as tapping, swiping, and pinching. The display presents various user interface pages, including the draft room page, scoreboard page, and other navigation elements, ensuring an intuitive and user-friendly experience.

In some implementations, the mobile device includes wireless communication capabilities, such as Wi-Fi and cellular connectivity, enabling the sports mogul application to access the internet and communicate with external servers. This connectivity allows the application to retrieve real-time updates on player and team statistics, synchronize user data across multiple devices, and facilitate communication between users within the application.

In some implementations, the mobile device includes a notification system that alerts users to important events related to the sports mogul application. These notifications can include draft start times, scoring updates, trade offers, and other relevant information. The notification system ensures that users remain informed and engaged with the application, even when they are not actively using it.

In some implementations, the mobile device includes an operating system (OS) that provides the necessary platform for running the sports mogul application. The application is designed to be compatible with popular mobile operating systems, such as iOS® and Android®, ensuring broad accessibility for users. The OS manages the processing device's hardware resources, handles background processes, and provides security features to protect user data and privacy.

In some implementations, the mobile device includes additional features that enhance the user experience of the sports mogul application. For example, the device's built-in camera can be used to scan QR codes for quick access to league information or to capture images for user profiles. The processing device's GPS functionality can provide location-based services, such as finding nearby sports events or connecting with local fantasy leagues.

In summary, a processing device suitable for implementing the sports mogul application includes a central processing unit, random access memory, storage memory, a touchscreen display, wireless communication capabilities, a notification system, and a compatible operating system. These components work together to provide a seamless and engaging user experience, allowing users to manage their multi-sport fantasy lineups conveniently from their mobile devices. Other processing devices, such as tablet computers, may include similar features for implementing a sports mogul application, and a processing device is used as just one example.

### Example Method of Managing a Multi-Sport Fantasy Application

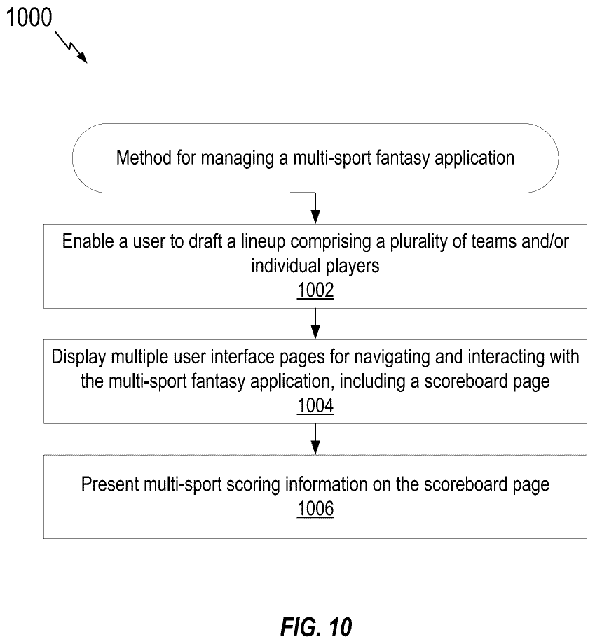

FIG. 10 depicts an example computer-implemented method 1000 for managing a multi-sport fantasy application.

FIG. 10 begins at block 1002 with enabling a user to draft a lineup comprising a plurality of teams and/or individual players. In some aspects, the lineup includes teams for team sports and individual players for individual sports, and the lineup includes teams and/or individual players from a plurality of sports leagues.

FIG. 10 then proceeds to block 1004 with displaying multiple user interface pages for navigating and interacting with the multi-sport fantasy application. In some aspects, the multiple user interface pages include a draft room page comprising a draft order subpage, a draft date subpage, a draft teams subpage, an individual league subpage and a scoreboard page.

FIG. 10 then proceeds to block 1006 with presenting multi-sport scoring information on the scoreboard page. In some aspects, the multi-sport scoring information includes: scores for each team and/or individual player in the user's lineup and scores for each team and/or individual player in a competitor's lineup.

In some aspects, method 1000 further includes generating the scoring information based on a scoring scheme. In some aspects, the scoring scheme includes one or more scoring settings for each team sport and each individual sport in the plurality of sports leagues.

In some aspects, the draft room page further comprises a user interface element for selecting and viewing the competitor's lineup.

In some aspects, method 1000 further includes enabling a user to select a draft order selected from a group consisting of snake draft, linear draft, auction draft, third round reversal, fixed draft order, and lottery draft.

In some aspects, method 1000 further includes notifying the user of one or more events associated with the multi-sport fantasy application, including at least a draft start time and a scoring update.

In some aspects, method 1000 further includes enabling the user to trade teams and/or individual players with the competitor.

In some aspects, method 1000 further includes enabling the user to create and/or join a multi-sport fantasy league.

In some aspects, method 1000 further includes enabling the user to communicate with the competitor within the multi-sport fantasy application.

In some aspects of method 1000, the multi-sport fantasy application is implemented on a mobile device comprising a touchscreen display, wireless communication capabilities, and a notification system.

In some aspects of method 1000, the scoreboard page further comprises a total score user interface element presenting a total score across all sports leagues for each user.

In some aspects of method 1000, the draft room page comprises a persistent user interface banner element configured to provide navigation across the plurality of user interface pages.

In some aspects, method 1000 further includes providing updates of player and team statistics to the user.

In some aspects, method 1000 further includes allowing the user to create a private league and to join a private league.

In some aspects, method 1000 further includes providing a chat feature for the user to communicate during a draft.

In some aspects, method 1000 further includes displaying a grid with leagues on one axis and users on another axis, indicating the draft order for each league.

In some aspects, method 1000 further includes displaying predicted scores using a first visual treatment and actual scores using a second visual treatment.

### Example Processing Device

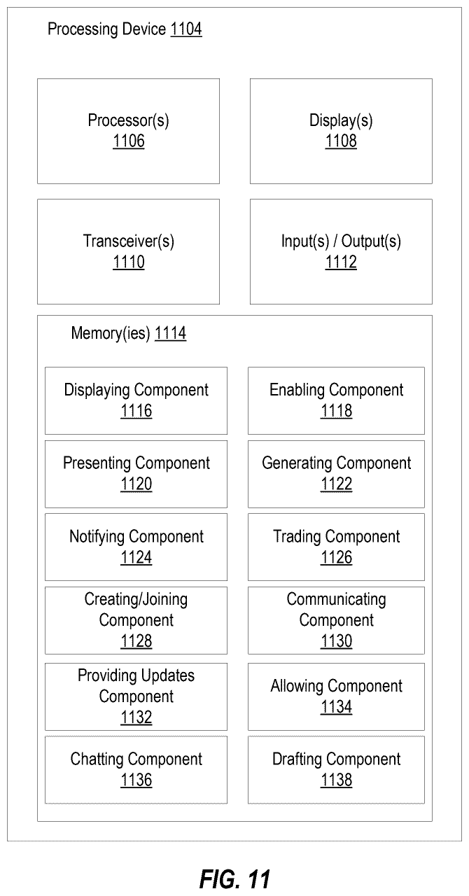

FIG. 11 depicts an example processing device 1104 configured to implement the sports mogul application described herein.

The processing device 1104 includes one or more processor(s) 1106 coupled, via one or more interconnects or buses (not depicted), to one or more display(s) 1108, one or more transceiver(s) 1110, input(s)/output(s) 1112, and one or more memories 1114.

The processor(s) 1106 may include general-purpose processing cores and, in certain implementations, graphics or signal processing capabilities for accelerating user interface rendering, animations, and data processing associated with multi-league scoring and draft operations.

The display(s) 1108 can include a touchscreen panel, high-refresh-rate screen, or other visual output device suitable for presenting draft room pages, league subpages, scoreboard pages, notifications, and other user interface views.

The transceiver(s) 1110 provide wireless and/or wired connectivity, such as Wi-Fi, cellular, Bluetooth, and Ethernet, enabling synchronization of user data, receipt of real-time statistics for teams and players, and communication features including draft chat and trade negotiations.

The input(s)/output(s) 1112 may include touch, keyboard, mouse, microphone, camera, speaker, haptic actuator, and peripheral ports to capture user selections, present audio/visual feedback, and support device accessories.

The memory or memories 1114 comprise non-transitory computer-readable media storing operating system services, application frameworks, data stores, and executable program modules which, when executed by the processor(s) 1106, cause the processing device 1104 to perform the actions described herein.

The memories 1114 may store various components corresponding to the functions of the sports mogul application described herein, including: a displaying component 1116 configured to render and present multiple user interface pages, subpages, grids, and visual elements, including displaying a grid with leagues on one axis and users on another axis indicating draft order and selections per round and displaying different visual treatment to predicted scores and actual scores, including color, font, emphasis, or iconography; an enabling component 1118 configured to enable a user to draft a lineup comprising teams and/or individual players across multiple sports leagues and to select draft orders; a presenting component 1120 configured to present multi-sport scoring information, totals across leagues, and visual treatments for predicted versus actual scores; a generating component 1122 configured to generate scoring information based on a configurable scoring scheme with league-specific settings; a notifying component 1124 configured to provide notifications of draft start times, scoring updates, trade offers, and other events; a trading component 1126 configured to facilitate proposing, evaluating, and executing trades involving teams and/or individual players between users; a creating/joining component 1128 configured to create leagues, join leagues, and manage private league access and membership; a communicating component 1130 configured to provide in-application messaging, including draft-room chat and direct messages between competitors; a providing updates component 1132 configured to retrieve and update player and team statistics, standings, fixtures, and injury/status feeds; an allowing component 1134 configured to allow creation and joining of private leagues with rule sets, access controls, and commissioner settings; a chatting component 1136 configured to present chat threads, message composition, and moderation tools during drafts and league play; and a drafting component 1138 configured to support snake, linear, auction, third-round reversal, fixed, and lottery orders.

In some implementations, the memories 1114 further store (not shown): lineup data store for user rosters, a league registry for available leagues and drafting schedules, a scoring scheme repository defining team-and player-level metrics per sport, a notification queue with delivery policies, a trade rules engine enforcing league constraints, a permissions subsystem for private league management, and a rendering pipeline that coordinates layout, animations, and compositing across the display(s) 1108.

The transceiver(s) 1110 may interface with remote services to authenticate users, synchronize state across devices, and fetch live statistics streams, while the input(s)/output(s) 1112 capture user interactions for drafting, trading, chatting, and navigation.

Executing the foregoing components causes the processor(s) 1106 to carry out the methods described herein, including enabling drafts across multiple sports leagues, displaying and navigating user interface pages and subpages, generating and presenting scoring information, notifying users of application events, facilitating trades and communications, and managing creation and joining of leagues, thereby implementing the sports mogul application on the processing device 1104.

### Example Clauses

Implementation examples are described in the following numbered clauses:
Clause 1: A computer-implemented method for managing a multi-sport fantasy application, the method comprising: enabling a user to draft a lineup comprising a plurality of teams and/or individual players, wherein: the lineup includes teams for team sports and individual players for individual sports, and the lineup includes teams and/or individual players from a plurality of sports leagues; displaying multiple user interface pages for navigating and interacting with the multi-sport fantasy application, including: a draft room page comprising a draft order subpage, a draft date subpage, a draft teams subpage, an individual league subpage; and a scoreboard page; and presenting scoring information on the scoreboard page, wherein the scoring information includes: scores for each team and/or individual player in the user's lineup; and scores for each team and/or individual player in a competitor's lineup.
Clause 2: The computer-implemented method of Clause 1, further comprising: generating the scoring information based on a scoring scheme, wherein the scoring scheme includes one or more scoring settings for each team sport and each individual sport in the plurality of sports leagues.
Clause 3: The computer-implemented method of any one of Clauses 1-2, wherein the draft room page further comprises a user interface element for selecting and viewing the competitor's lineup.
Clause 4: The computer-implemented method of any one of Clauses 1-3, further comprising enabling a user to select a draft order selected from a group consisting of snake draft, linear draft, auction draft, third round reversal, fixed draft order, and lottery draft.
Clause 5: The computer-implemented method of any one of Clauses 1-4, further comprising notifying the user of one or more events associated with the multi-sport fantasy application, including at least a draft start time and a scoring update.
Clause 6: The computer-implemented method of any one of Clauses 1-5, further comprising enabling the user to trade teams and/or individual players with the competitor.
Clause 7: The computer-implemented method of any one of Clauses 1-6, further comprising enabling the user to create and/or join a multi-sport fantasy league.
Clause 8: The computer-implemented method of any one of Clauses 1-7, further comprising enabling the user to communicate with the competitor within the multi-sport fantasy application.
Clause 9: The computer-implemented method of any one of Clauses 1-8, wherein the multi-sport fantasy application is implemented on a mobile device comprising a touchscreen display, wireless communication capabilities, and a notification system.
Clause 10: The computer-implemented method of any one of Clauses 1-9, wherein the scoreboard page further comprises a total score user interface element presenting a total score across all sports leagues for each user.
Clause 11: The computer-implemented method of any one of Clauses 1-10, wherein the draft room page comprises a persistent user interface banner element configured to provide navigation across the plurality of user interface pages.
Clause 12: The computer-implemented method of any one of Clauses 1-11, further comprising providing updates of player and team statistics to the user.
Clause 13: The computer-implemented method of any one of Clauses 1-12, further comprising allowing the user to create a private league and to join a private league.
Clause 14: The computer-implemented method of any one of Clauses 1-13, further comprising providing a chat feature for the user to communicate during a draft.
Clause 15: The computer-implemented method of any one of Clauses 1-14, further comprising displaying a grid with leagues on one axis and users on another axis, indicating the draft order for each league.
Clause 16: The computer-implemented method of any one of Clauses 1-15, further comprising displaying predicted scores using a first visual treatment and actual scores using a second visual treatment.
Clause 17: A processing system, comprising: a memory comprising computer-executable instructions; and a processor configured to execute the computer-executable instructions and cause the processing system to perform a method in accordance with any one of Clauses 1-16.
Clause 18: A processing system, comprising means for performing a method in accordance with any one of Clauses 1-16.
Clause 19: A non-transitory computer-readable medium storing program code for causing a processing system to perform the steps of any one of Clauses 1-16.
Clause 20: A computer program product embodied on a computer-readable storage medium comprising code for performing a method in accordance with any one of Clauses 1-16.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A computer-implemented method for managing a multi-sport fantasy application, comprising:
enabling a user to draft a lineup comprising a plurality of teams and/or individual players, wherein:
the lineup includes teams for team sports and individual players for individual sports, and
the lineup includes teams and/or individual players from a plurality of sports leagues;
displaying a plurality of user interface pages for navigating and interacting with the multi-sport fantasy application, including:
a draft room page comprising a draft order subpage, a draft date subpage, a draft teams subpage, an individual league subpage; and
a scoreboard page; and
presenting multi-sport scoring information on the scoreboard page, wherein the multi-sport scoring information includes:
scores for each team and/or individual player in the user's lineup; and
scores for each team and/or individual player in a competitor's lineup.

2. The computer-implemented method of claim 1, further comprising:
generating the multi-sport scoring information based on a scoring scheme,
wherein the scoring scheme includes one or more scoring settings for each team sport and each individual sport in the plurality of sports leagues.

3. The computer-implemented method of claim 1, wherein the draft room page further comprises a user interface element for selecting and viewing the competitor's lineup.

4. The computer-implemented method of claim 1, further comprising enabling a user to select a draft order selected from a group consisting of snake draft, linear draft, auction draft, third round reversal, fixed draft order, and lottery draft.

5. The computer-implemented method of claim 1, further comprising notifying the user of one or more events associated with the multi-sport fantasy application, including at least a draft start time and a scoring update.

6. The computer-implemented method of claim 1, further comprising enabling the user to trade teams and/or individual players with a competitor.

7. The computer-implemented method of claim 1, further comprising enabling the user to create and/or join a multi-sport fantasy league.

8. The computer-implemented method of claim 1, further comprising enabling the user to communicate with a competitor within the multi-sport fantasy application.

9. The computer-implemented method of claim 1, wherein the multi-sport fantasy application is implemented on a mobile device comprising a touchscreen display, wireless communication capabilities, and a notification system.

10. The computer-implemented method of claim 1, wherein the scoreboard page further comprises a total score user interface element presenting a total score across all sports leagues for each user.

11. The computer-implemented method of claim 1, wherein the draft room page comprises a persistent user interface banner element configured to provide navigation across the plurality of user interface pages.

12. The computer-implemented method of claim 1, further comprising providing updates of player and team statistics to the user.

13. The computer-implemented method of claim 1, further comprising allowing the user to create a private league and to join a private league.

14. The computer-implemented method of claim 1, further comprising providing a chat feature for the user to communicate during a draft.

15. The computer-implemented method of claim 1, further comprising displaying a grid with leagues on one axis and users on another axis, indicating a draft order for each league.

16. The computer-implemented method of claim 1, further comprising displaying predicted scores using a first visual treatment and actual scores using a second visual treatment.

17. A mobile processing device, comprising:
a touchscreen display;
a wireless communication transceiver;
a notification system;
one or more memories comprising computer-executable instructions; and
one or more processors configured to execute the computer-executable instructions and cause the mobile processing device to perform a method according to claim 1.
